(19) United States
(12) Patent Application Publication
(10) Pub. No.: US 2015/0142834 A1
(43) Pub. Date: May 21, 2015

(54) METHOD AND APPARATUS FOR GENERATING AGRICULTURAL SEMANTIC IMAGE INFORMATION

(71) Applicant: ELECTRONICS AND TELECOMMUNICATIONS RESEARCH INSTITUTE, Daejeon (KR)

(72) Inventors: Hae Dong LEE, Daegu (KR); Ae Kyeung MOON, Daegu (KR); Dong Wan RYOO, Daejeon (KR); Soo In LEE, Daegu (KR)

(73) Assignee: ELECTRONICS AND TELECOMMUNICATIONS RESEARCH INSTITUTE, Daejeon (KR)

(21) Appl. No.: 14/300,447

(22) Filed: Jun. 10, 2014

(30) Foreign Application Priority Data
Nov. 18, 2013 (KR) 10-2013-0140113

(51) Int. Cl. G06F 17/30; G06T 7/00

(52) U.S. Cl. CPC G06F 17/30268; G06T 7/0002; G06T 2207/30188; G06T 2207/10004; G06T 2210/32
USPC 707/755; 707/736

(57) ABSTRACT

A method and apparatus for generating agricultural semantic image information are provided to manage crop image information and agricultural environmental information as an object in an integrated manner. The apparatus generates agricultural semantic image information through these steps: receiving primary agricultural environmental information from each sensor of an agricultural environment semantic adaptation system; generating secondary agricultural environmental information based on the primary agricultural environmental information; receiving image information and still lo images from imaging means of the agricultural environment semantic adaptation system; extracting growth state information from the still images; and recording the primary agricultural environmental information, secondary agricultural environmental information, and growth state information as metadata for the image information.

### CROSS-REFERENCE TO RELATED APPLICATION

This application claims priority to and the benefit of Korean Patent Application No. 10-2013-0140113 filed in the Korean Intellectual Property Office on Nov. 18, 2013, the entire contents of which are incorporated herein by reference.

### BACKGROUND OF THE INVENTION

(a) Field of the Invention

The present invention relates to a method and apparatus for generating agricultural semantic image information, which are capable of integrating crop image information and agricultural environmental information, and storing, processing, and using the integrated information.

(b) Description of the Related Art

In recent years, IT technologies have been combined with agriculture to improve agricultural productivity and save labor. Combining IT technologies with agriculture allows monitoring of the state of crop growth by closed circuit TV

(CCTV) or network cameras. Also, agricultural environmental information such as temperature, relative humidity, light intensity, etc. of a planting area can be collected by an observatory, digital sensors, thermocouples, etc., and used to control the agricultural environment. As such, IT technologies such as environment surveillance technology, image processing technology, and DB query technology can be combined with agriculture.

### SUMMARY OF THE INVENTION

The present invention has been made in an effort to provide a method and apparatus for generating agricultural semantic image information in an agricultural environment semantic adaption system capable of effectively combining IT technologies such as environmental surveillance technology, image processing technology, and DB query technology with agriculture.

An exemplary embodiment of the present invention provides a method for generating agricultural semantic image information. The method for generating agricultural semantic image information includes: receiving primary agricultural environmental information from each sensor of an agricultural environment semantic adaptation system; generating secondary agricultural environmental information based on the primary agricultural environmental information; receiving image information and still images from imaging means of the agricultural environment semantic adaptation system; extracting growth state information from the still images; and recording the primary agricultural environmental information, secondary agricultural environmental information, and growth state information as metadata for the image information.

In the method for generating agricultural semantic image information, the primary agricultural environmental information may include temperature information, humidity information, CO₂ concentration information, light intensity information, wind speed and wind direction information, electrical conductivity information of a planting region, and acidity information of the planting region.

In the method for generating agricultural semantic image information, the generating of secondary agricultural environmental information may include calculating an average value, maximum value, minimum value, and integrated value of the primary agricultural environmental information for a preset period.

In the method for generating agricultural semantic image information, the recording may include: parsing the image information; recording the primary agricultural information, secondary agricultural information, and growth state information as metadata for the parsed image information; and generating agricultural image information based on the image information for which metadata is recorded.

In the method for generating agricultural semantic image information, the generating of agricultural semantic image information may include encoding the image information for which metadata is recorded.

The method for generating agricultural semantic image information may include transmitting the agricultural semantic image information to a user's agricultural information terminal.

Another embodiment of the present invention provides an apparatus for generating agricultural semantic image information. The apparatus for generating agricultural semantic image information may include: a sensed information receiver for receiving primary agricultural environmental information from each sensor of an agricultural environment semantic adaptation system; an environmental information processor for generating secondary agricultural environmental information based on the primary agricultural environmental information; a file format parser for receiving image information from imaging means of the agricultural environment semantic adaptation system and parsing the image information; a crop image processor for receiving still images from the imaging means of the agricultural environment semantic adaptation system and extracting growth state information from the still images; and a semantic encoder for recording the primary agricultural environmental information, secondary agricultural environmental information, and growth state information as metadata for the image information.

In the apparatus for generating agricultural semantic image information, the primary agricultural environmental information may include temperature information, humidity information, CO₂ concentration information, light intensity information, wind speed and wind direction information, electrical conductivity information of a planting region, and acidity information of the planting region.

In the apparatus for generating agricultural semantic image information, the environmental information processor may calculate the average value, maximum value, minimum value, and integrated value of the primary agricultural environmental information for a preset period.

In the apparatus for generating agricultural semantic image information, the semantic encoder may generate agricultural semantic image information based on the image information for which metadata is recorded.

In the apparatus for generating agricultural semantic image information, the semantic encoder may encode the image information for which metadata is recorded to generate agricultural semantic image information.

The apparatus for generating agricultural semantic image information may include semantic image storage for storing the agricultural semantic image information and transmitting the same to a user's agricultural information terminal.

According to an embodiment of the present invention, crop image information and agricultural environmental information, which are managed as separate factors in the conventional art, can be semantically tagged as an object through a semantic technology based on agricultural environmental information according to the exemplary embodiment of the present invention. Accordingly, even if crop image information and agricultural environmental information are not synchronized with each other, the crop image information for which the agricultural environmental information is recorded as metadata can be formed as a database, thus increasing the efficiency of information management. Moreover, a variety of applications such as multiple information-based monitoring services, agricultural semantic information-based diagnosis and prediction services, etc., can be created by making use of the agricultural environmental information recorded as metadata for the crop image information.

### BRIEF DESCRIPTION OF THE DRAWINGS

FIG. 1 is a view showing an agricultural environment semantic adaptation system according to an exemplary embodiment of the present invention.

FIG. 2 is a view showing a semantic generator of the agricultural environment semantic adaptation system according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. Further, terms such as “-unit”, “-er”, “module”, “block”, etc.

mean units that processes at least one function or operation and can be implemented by hardware or software or a combination of hardware and software.

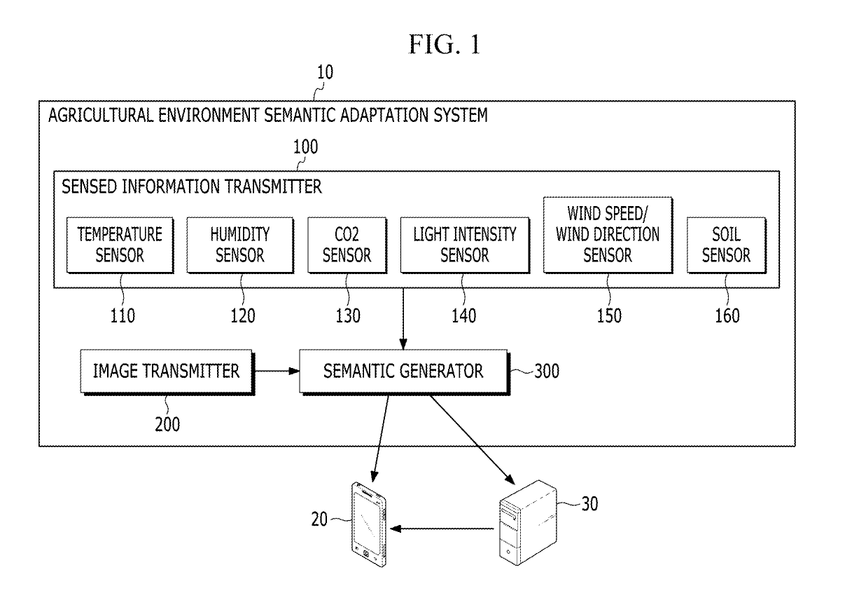

FIG. 1 is a view showing an agricultural environment semantic adaptation system according to an exemplary embodiment of the present invention.

The agricultural environment semantic adaptation system 10 according to the exemplary embodiment of the present invention includes a sensed information transmitter 100, an image transmitter 200, and a semantic generator 300.

The sensed information transmitter 100 transmits agricultural environment information sensed by each sensor to the semantic generator 300. Referring to FIG. 1, the sensed information transmitter 100 according to the exemplary embodiment of the present invention may include a temperature sensor 110, a humidity sensor 120, a CO₂ sensor 130, a light intensity sensor 140, a wind speed/wind direction sensor 150, a soil sensor 160, etc.

Table 1 shows agricultural environmental information. (Table 1)

TABLE 1

| Attributes | Unit | Description |
|---|---|---|
| Inside temperature | ° C. | Temperature inside facility |
| Outside temperature | ° C. | Outside temperature |
| Inside relative | % | Relative humidity inside facility |
| humidity | | |
| Outside relative | % | Outside relative temperature |
| temperature | | |
| Indoor CO₂ | Ppm | CO₂ concentration inside facility |
| concentration | | |
| Light intensity | W/m² | Amount of solar radiation from outside |
| Wind speed | m/s | Outside wind speed |
| Wind direction | | Outside wind direction |
| Electrical conductivity | | Electrical conductivity of planting region |
| (E.C) | | (soil or water) |
| acidity (ph) | Ph | Acidity of planting region (soil or water) |
| Leaf area index | | State of crops |
| Initial length | Cm | State of crops |

The image transmitter 200 periodically generates image information, still images, etc. of crops by imaging means such as CCTV or network cameras, and transmits them to the semantic generator 300.

The semantic generator 300 integrates agricultural environmental information with the crop image information to generate agricultural semantic image information. Next, the semantic generator 300 transmits the generated agricultural semantic image information to an agricultural information terminal 20 and a diagnosis and prediction system 30. The functions of the semantic generator 300 will be discussed below in detail.

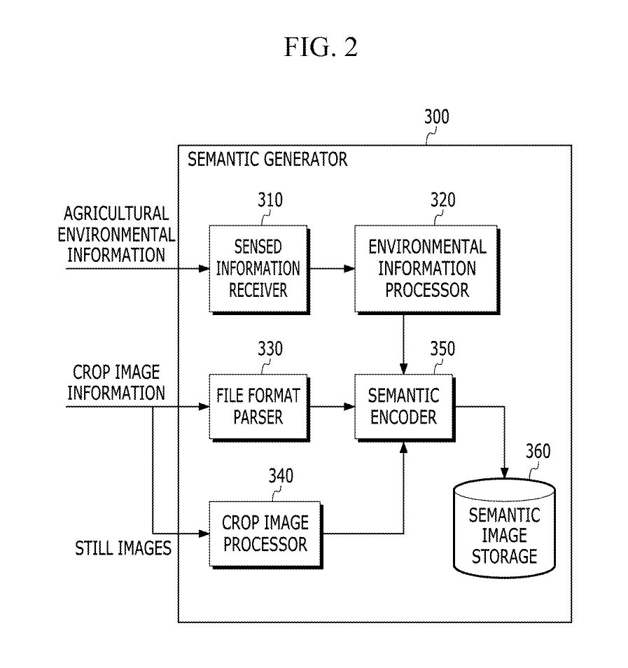

FIG. 2 is a view showing a semantic generator of the agricultural environment semantic adaptation system according to the exemplary embodiment of the present invention.

The semantic generator according to the exemplary embodiment of the present invention includes a sensed information receiver 310, an environmental information processor 320, a file format parser 330, a crop image processor 340, a semantic encoder 350, and semantic image storage 360.

The sensed information receiver 310 receives agricultural environmental information from the sensed information transmitter 100 and transmits it to the environmental information processor 320.

The environmental information processor 320 calculates the average value, maximum value, minimum value, and integrated value of the agricultural environmental information for a preset period to generate secondary agricultural environmental information, and transmits the agricultural environmental information and the secondary agricultural environmental information to the semantic encoder 350.

The file format parser 330 receives the crop image information from the image transmitter 200 and parses it.

The crop image processor 230 extracts crop growth state information from the still images corresponding to the crop image information received from the image transmitter 200.

The semantic encoder 350 records and encodes agricultural environmental information, secondary agricultural environmental information, and growth state information as metadata for the parsed image information to generate semantic image information. Because the image information is periodically transmitted from the image transmitter 200, the agricultural environmental information, secondary agricultural environmental information, and growth state information are periodically recorded for the image information. As an agricultural semantic image file is indexed in a time-series manner and provided to a user, the user can choose agricultural semantic information for a desired time range and receive agricultural environmental information for this time range, and analyze the growth state of the crops three-dimensionally.

The semantic image storage 360 stores the agricultural semantic image information in a database and manages it. Referring again to FIG. 1, the agricultural semantic image information can be transmitted to the agricultural information terminal 20 and the system 30 that provides diagnosis and prediction services for agriculture. The diagnosis and prediction system 30 is able to provide the agricultural information terminal 20 with services such as agricultural production prediction, disease and insect forecasting, etc. based on the agricultural semantic image information, and the user is able to reproduce the agricultural semantic information by the agricultural information terminal 20 and use the services of the diagnosis and prediction system 30.

As seen above, crop image information and agricultural environmental information, which are managed as separate factors in the conventional art, can be semantically tagged as an object through a semantic technology based on agricultural environmental information according to the exemplary embodiment of the present invention. Accordingly, even if crop image information and agricultural environmental information are not synchronized with each other, the crop image information for which the agricultural environmental information is recorded as metadata can be made into a database, thus increasing the lo efficiency of information management. Moreover, a variety of applications such as multiple information-based monitoring services, agricultural semantic information-based diagnosis and prediction services, etc. can be created by making use of the agricultural environmental information recorded as metadata for the crop image information.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for generating agricultural semantic image information, the method comprising:
receiving primary agricultural environmental information from each sensor of an agricultural environment system;
generating secondary agricultural environmental information based on the primary agricultural environmental information;
receiving image information and still images from imaging means of the agricultural environment system;
extracting growth state information from the still images; and
recording the primary agricultural environmental information, secondary agricultural environmental information, and growth state information as metadata for the image information.

2. The method of claim 1, wherein the primary agricultural environmental information comprises temperature information, humidity information, CO₂ concentration information, light intensity information, wind speed and wind direction information, electrical conductivity information of a planting region, and acidity information of the planting region.

3. The method of claim 1, wherein the generating of secondary agricultural environmental information comprises calculating an average value, maximum value, minimum value, and integrated value of the primary agricultural environmental information for a preset period.

4. The method of claim 1, wherein
the recording comprises:
parsing the image information;
recording the primary agricultural information, secondary agricultural information, and growth state information as metadata for the parsed image information; and
generating agricultural semantic image information based on the image information for which metadata is recorded.

5. The method of claim 4, wherein the generating of agricultural semantic image information comprises encoding the image information for which metadata is recorded.

6. The method of claim 4, further comprising transmitting the agricultural semantic image information to a user's agricultural information terminal.

7. An apparatus for generating agricultural semantic image information, the apparatus comprising:
a sensed information receiver for receiving primary agricultural environmental information from each sensor of an agricultural environment system;
an environmental information processor for generating secondary agricultural environmental information based on the primary agricultural environmental information;
a file format parser for receiving image information from imaging means of the agricultural environment system and parsing the image information;
a crop image processor for receiving still images from the imaging means of the agricultural environment system and extracting growth state information from the still images; and
a semantic encoder for recording the primary agricultural environmental information, secondary agricultural environmental information, and growth state information as metadata for the image information.

8. The apparatus of claim 7, wherein the primary agricultural environmental information comprises temperature information, humidity information, CO₂ concentration information, light intensity information, wind speed and wind direction information, electrical conductivity information of a planting region, and acidity information of the planting region.

9. The apparatus of claim 7, wherein the environmental information processor calculates an average value, maximum value, minimum value, and integrated value of the primary agricultural environmental information for a preset period.

10. The apparatus of claim 7, wherein the semantic encoder generates the agricultural semantic image information based on the image information for which metadata is recorded.

11. The apparatus of claim 10, wherein the semantic encoder encodes the image information for which metadata is recorded to generate the agricultural semantic image information.

12. The apparatus of claim 10, further comprising semantic image storage for storing the agricultural semantic image information and transmitting the same to a user's agricultural information terminal.
